(19) United States
(12) Patent Application Publication
(10) Pub. No.: US 2007/0089825 A1
(43) Pub. Date: Apr. 26, 2007

(54) SYSTEM AND METHOD FOR MANAGING FEEDERS OF A SURFACE MOUNT MACHINE

(75) Inventors: TSUNG-CHIH TSAI, Tu-Cheng (TW); Feng-Hua Zhou, Shenzhen (CN); Chun-Guang Zhao, Shenzhen (CN); Wei Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,414

(22) Filed: Aug. 4, 2006

(30) Foreign Application Priority Data
Oct. 26, 2005 (CN) 200510100784.6

(51) Int. Cl. B32B 37/00

(52) U.S. Cl. 156/64

(57) ABSTRACT

A method for managing feeders of a surface mount machine includes the steps of: initializing all IC cards of the feeders; scanning the feeders; inputting initial operational information of each feeder to a corresponding IC card and a first document; inputting current operational information of each feeder to its IC card and the first document periodically; determining whether the surface mount machine needs to continue operating; inputting end information to the corresponding IC card and the first document if the surface mount machine does not need to continue operating. A related system is also disclosed.

### 1. FIELD OF THE INVENTION

The present invention relates to systems and methods for managing feeders, and more particularly to a system and method for managing feeders of a surface mount machine.

### 2. DESCRIPTION OF RELATED ART

In manufacturing, electronic devices and their respective electrical components are usually assembled onto a printed circuit board (PCB) by soldering. Since the eighteenth century, these electrical components are centimeters in size and can be soldered onto a PCB either by manual operation or by automatic machines. Nowadays, the size of electrical components has shrunk to the millimeters, resulting in the assembly of electrical components onto PCBs becoming more and more dependent on automatic machines. These automatic machines can pick up and assemble the electrical component quickly and accurately and includes a surface mount that may pick up and assemble thousands of electrical components having similar size, shape, and color onto a PCB.

A surface mount machine is a tool used for assembling the electronic components onto the surface of the printed circuit board. A working mode procedure of the surface mount machine is to use an adsorption device to adsorb an electronic component, dispose the electronic component on the designed position of the printed circuit board, and dissolve tin solder to electrically assemble it onto the printed circuit board.

A feeder is a device filled with material supplied to the surface mount machine. A type of present feeder includes a mechanical feeder, an electric feeder, and a pneumatic feeder. An electric feeder that includes a central processing unit and a storage device for controlling the electric motor feeds material and recording data is called power feeder. Components information is inputted into the power feeder using an inputting device that is linked with the power feeder. Then, components information can be read from the power feeder when necessary.

However, each feeder has a working life, at present, feeders can only store components information and production information, but can't follow the status of itself. For example, the number of feeder working times, the model of the material tray that fit for the feeder, the distance between two near tooth of the feeder, the correcting result of the feeder and the index of parameter, etc.

What is needed, therefore, is a system and method for managing a feeder of a surface mount machine which can know production information in time and follow the feeder.

### SUMMARY OF THE INVENTION

A system for managing feeders of a surface mount machine includes a plurality of feeders, a surface mount machine, and a cart connected with the surface mount machine and the feeders. The surface mount machine includes a main controller. The main controller includes an initializing module for initializing an IC card of each feeder, scanning all the feeders and creating a first document; an inputting module for inputting initial operational information of each feeder to a corresponding IC card and the first document, inputting current operational information of the feeder to the IC card and the first document periodically; and a determining module for determining whether the surface mount machine needs to continue operating.

A method for managing feeders of a surface mount machine includes the steps of: initializing all IC cards of the feeders; scanning the feeders; inputting initial operational information of each feeder to a corresponding IC card and a first document; inputting current operational information of each feeder to its IC card and the first document periodically; determining whether the surface mount machine needs to continue operating; inputting end information to the corresponding IC card and the first document if the surface mount machine does not need to continue operating.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration of a system for managing feeders of a surface mount machine in accordance with a preferred embodiment;

FIG. 2 is a schematic diagram of main function modules of a main controller of FIG. 1;

FIG. 3 is a flowchart of a method for managing feeders of a surface mount machine in accordance with a preferred embodiment; and

FIG. 4 is a flowchart of a method for correcting a feeder in accordance with a preferred embodiment.

### DETAILED DESCRIPTION OF THE INVENTION

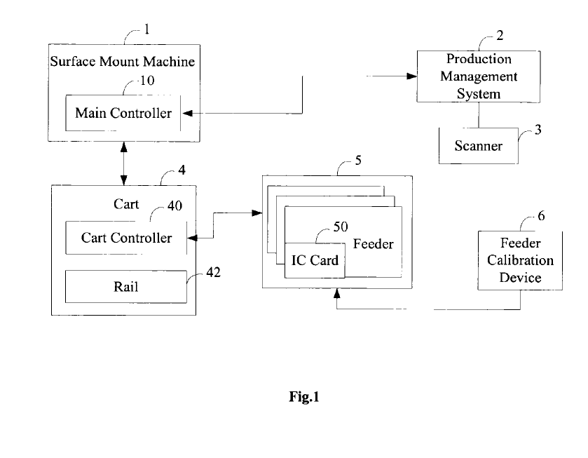

FIG. 1 is a schematic diagram of hardware configuration of a system for managing feeders of a surface mount machine (hereinafter, “the system”) in accordance with a preferred embodiment. The system typically includes a surface mount machine 1, a production management system 2, a scanner 3, a cart 4, a plurality of feeders 5, and a feeder calibration device 6. The surface mount machine 1 is linked with the production management system 2 and the cart 4, and can assemble components from the feeders 5 to respective positions of a printed circuit board (PCB) accurately. The surface mount machine 1 includes a main controller 10. The cart 4 is linked with the feeders 5, and includes a cart controller 40 and a plurality of rails 42 for controlling the surface mount machine 1 to communicate with the feeders 5. Each feeder 5 has an integrated circuit card (IC card) 50 for storing information.

The main controller 10 may be a processor of the surface mount machine 1, and is programmed for obtaining information stored in the IC cards 50 via the cart controller 40 and for inputting information to the IC cards 50. The main controller 10 may be further programmed for uploading parameter documents to the production management system 2, downloading production programs from the production management system 2, determining whether any feeders 5 is in a wrong rail according to a rail address list, and prompting an operator to deal with any wrong rail problems if any feeder 5 is in a wrong rail. The wrong rail problems happen when any feeder 5 is not in a corresponding rail 42.

The production management system 2 is linked with the scanner 3, and may be an application software installed in a computer that can obtain and store identifications (IDs) of the cart 4, the feeders 5, and components information.

Each feeder 5 is used for feeding components to the surface mount machine 1, and may be any one of a cushion feeder, a tray feeder, and a tape feeder. Each IC card 50 stores information including an ID of a corresponding feeder 5, component mounting information, repair information and/or correctional information of the feeder 5.

The feeder calibration device 6 is used for repairing and/or correcting feeders 5 if necessary, and for inputting IDs of the feeders 5, repair information, and/or correctional information of the feeders 5 to respective IC cards 50.

The cart controller 40 is used for storing the ID of the cart 4, the repair information, and/or correctional information of the cart 4. The cart controller 40 may be used as a communication passage between the surface mount machine 1 and the feeders 5.

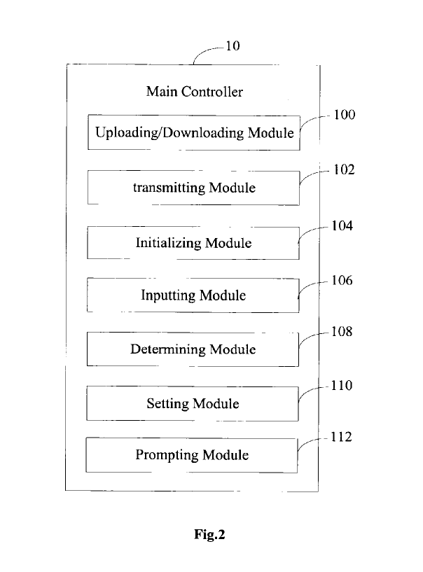

FIG. 2 is a schematic diagram of the main function modules of the main controller 10. The main controller 10 includes an uploading/downloading module 100, a transmitting module 102, an initializing module 104, an inputting module 106, a determining module 108, a setting module 110, and a prompting module 112.

The uploading/downloading module 100 is programmed for uploading parameter documents to the production management system 2, downloading production programs from the production management system 2, and storing components information and the occupied rails 42 information to a document A.

The transmitting module 102 is programmed for creating a rail address list according to the document A and transmitting the rail address list to the cart controller 40 in order to determine a position for each rail 42.

The initializing module 104 is programmed for initializing the IC card 50 of each feeder 5, scanning all the feeders and creating a document B. The initialization process includes resetting the IC card 50, reading information stored in the IC card 50, and determining whether the IC card 50 works normally.

The inputting module 106 is used for inputting initial operational information of each feeder 5 to its IC card 50 and a document B, inputting current operational information of the feeder 5 to the IC card 50 and the document B periodically, and inputting end information to the IC card 50 and the document B.

The determining module 108 is programmed for determining whether the document A has been updated, whether any feeder 5 is in a wrong rail according to the rail address list, whether the surface mount machine 1 needs to continue operating, and whether any feeder 5 needs to be repaired and/or corrected.

The setting module 110 is programmed for setting a time interval of inputting current operating information of the feeder 5 to a corresponding IC card 50 and the document B for the inputting module 106.

The prompting module 112 is programmed for prompting an output if any abnormal situation occurs, for example, if any feeder 5 is in the wrong rail, or if the communication between the feeder 5 and the main controller 10, the cart controller 40 is not ok.

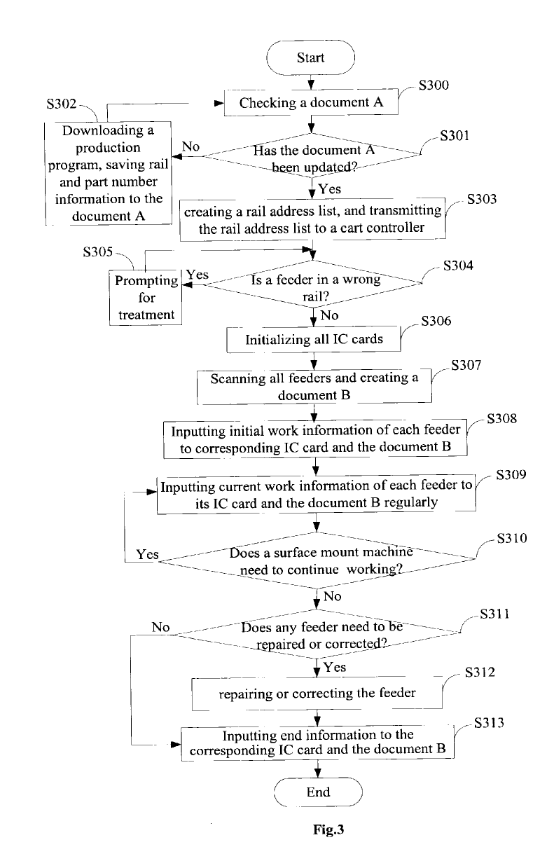

FIG. 3 is a flowchart of a method for managing feeders of the surface mount machine in accordance with a preferred embodiment by utilizing the system of FIG. 1. In step S300, the determining module 108 reads the document A. In step S301, the determining module 108 determines whether the document A has been updated. If the document A has not been updated, in step S302, the uploading/downloading module 100 downloads the production program from the production management system 2 and stores in the document A information of the occupied rails 42 and information of components to be mounted.

If the document A has been updated, in step S303, the transmitting module 102 creates the rail address list, and transmits the rail address list to the cart controller 40. In step S304, the determining module 108 determines whether any feeder 5 is in a wrong rail. If the feeder 5 is in the wrong rail, in step 305, the prompting module 112 prompts an operator to deal with the wrong rail problem promptly. If no feeder 5 is in the wrong rail, in the step S306, the initializing module 104 initializes all the IC cards 50. In step S307, the initializing module 104 scans all the feeders 5 and obtains feeder information, and stores the feeder information in the document B.

In step S308, the inputting module 106 inputs initial operational information of each feeder 5 to its IC card 50 and the document B. In step S309, the inputting module 106 inputs current operational information of each feeder 5 to its IC card 50 and the document B periodically.

In step 310, the determining module 108 determines whether the surface mount machine 1 needs to continue operating. If the surface mount machine 1 needs to continue operating, the procedure returns to step S309 described above. If the surface mount machine 1 does not need to continue operating, in step S311, the determining module 108 determines whether any feeder 5 needs to be repaired or corrected.

If no feeder 5 needs to be repaired or corrected, the procedure goes directly to step S313 described below. Otherwise, if any feeder 5 needs to be repaired or corrected, in step S312, the operator repairs or corrects the feeder 5. In step S313, the inputting module 106 inputs end information to all the IC cards 50 and the document B, and the procedure ends.

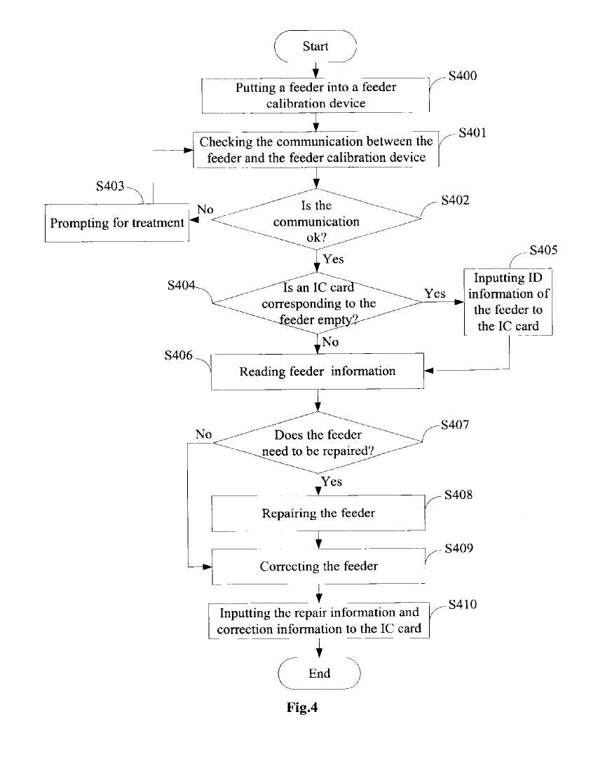

FIG. 4 is a flowchart of a method for correcting the feeder 5 in accordance with the preferred embodiment. In step S400, an operator puts the feeder 5 that needs to be corrected into the feeder calibration device 6. In step S401, the determining module 108 checks the communication between the feeder 5 and the feeder calibration device 6. In step S402, the determining module 108 determines whether the communication between the feeder 5 and the feeder calibration device 6 is in good condition. If the communication between the feeder 5 and the feeder calibration device 6 is not in good condition, in step S403, the feeder calibration device 6 prompts an output, and the procedure returns to step S401 described above.

If the communication between the feeder 5 and the feeder calibration device 6 is in good condition, in step S404, the determining module 108 determines whether the IC card 50 of the feeder 5 is empty. If the IC card 50 is not empty, the procedure goes directly to step S406. If the IC card 50 is empty, in step S405, the inputting module 106 inputs ID information of the feeder 5 to the IC card 50.

In step S406, the feeder calibration device 6 reads feeder information stored in the IC card 50. In step S407, the determining module 108 determines whether the feeder 5 needs to be repaired according to the feeder information read. If the feeder 5 does not need to be repaired, the procedure goes directly to step S409 described below. Otherwise, if the feeder 5 needs to be repaired, in step S408, a repairer repairs the feeder 5. In step S409, the repairer corrects the repaired feeder 5 via the feeder calibration device 6. In step S410, the inputting module 106 inputs the repair information and correctional information to the IC card 50.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A controller for managing feeders of a surface mount machine, the controller comprising:
an initializing module for initializing an integrated circuit card of each feeder, scanning all the feeders and creating a first document;
an inputting module for inputting initial operational information of each feeder to a corresponding integrated circuit card and the first document, inputting current operational information of the feeder to the integrated circuit card and the first document periodically; and
a determining module for determining whether the surface mount machine needs to continue operating.

2. The controller as claimed in claim 1, wherein the inputting module is further used for inputting end information to the integrated circuit card and the first document.

3. The controller as claimed in claim 1, wherein the determining module is further programmed for determining whether a second document has been updated, determining whether a feeder is in a wrong rail according to a rail address list, and determining whether any feeder needs to be repaired and/or corrected.

4. The controller as claimed in claim 3, further comprising:
an uploading/downloading module for uploading parameter documents to a production management system, downloading production programs from the production management system, and writing in the second document information on occupied rails and the information of components to be mounted; and
a transmitting module for creating the rail address list according to the second document, and transmitting the rail address list to a cart controller in the cart.

5. The controller as claimed in claim 4, further comprising:
a setting module for setting a time interval of inputting current operating information of the feeder to the integrated circuit card and the first document; and
a prompting module for prompting an output if any abnormal situation occurs.

6. A method for managing feeders of a surface mount machine, comprising the steps of:
initializing all integrated circuit cards of the feeders;
scanning the feeders;
inputting initial operational information of each feeder to a corresponding integrated circuit card and a first document;
inputting current operational information of each feeder to its integrated circuit card and a first document periodically;
determining whether the surface mount machine needs to continue operating; and inputting end information to the corresponding integrated circuit card and the first document if the surface mount machine does not need to continue operating.

7. The method according to claim 6, further comprising the steps of:
checking a second document;
determining whether the second document has been updated;
creating a rail address list according to the second document, and transmitting the rail address list to a cart controller if the second document has been updated; and
determining whether any feeder is in a wrong rail.

8. The method according to claim 7, further comprising the steps of:
determining whether any feeder needs to be repaired or corrected; and
repairing or correcting the feeder if the feeder needs to be repaired or corrected.

9. The method according to claim 8, wherein the repairing step comprises the steps of:
putting the feeder into a feeder calibration device;
checking the communication between the feeder and the feeder calibration device;
determining whether the communication is in good working condition;
determining whether an integrated circuit card corresponding to the feeder is empty if the communication is in good working condition;
reading feeder information if the integrated circuit card corresponding to the feeder is not empty;
determining whether the feeder needs to be repaired;
repairing the feeder if the feeder needs to be repaired;
correcting the feeder; and
inputting the repair information and correctional information to the integrated circuit card.

10. A feeding system comprising a plurality of feeders, a surface mount machine, and a cart connected with the surface mount machine and the feeders, the surface mount machine having a main controller, the main controller comprising:
an initializing module for initializing an integrated circuit card of each feeder, scanning all the feeders and creating a first document;
an inputting module for inputting initial operational information of each feeder to a corresponding integrated circuit card and the first document, inputting current operational information of the feeder to the integrated circuit card and the first document periodically; and
a determining module for determining whether the surface mount machine needs to continue operating.

11. The feeding system as claimed in claim 10, wherein the inputting module is further programmed for inputting end information to the integrated circuit card and the first document.

12. The feeding system as claimed in claim 10, wherein the determining module is further programmed for determining whether a second document has been updated, determining whether a feeder is in a wrong rail according to a rail address list, and determining whether any feeder needs to be repaired and/or corrected.

13. The feeding system as claimed in claim 12, wherein the main controller further comprises:
an uploading/downloading module for uploading parameter documents to a production management system, downloading production programs from the production management system, and writing in the second document information on occupied rails and the information of components to be mounted; and
a transmitting module for creating the rail address list according to the second document, and transmitting the rail address list to a cart controller in the cart.

14. The feeding system as claimed in claim 13, wherein the main controller further comprises:
a setting module for setting a time interval of inputting current operating information of the feeder to the integrated circuit card and the first document; and
a prompting module for prompting an output if any abnormal situation occurs.

15. The feeding system as claimed in claim 10, further comprising:
a feeder calibration device for repairing and/or correcting the feeders if necessary, and inputting the repair information and correctional information of the feeders to respective integrated circuit carts.
